(19) United States
(12) Patent Application Publication
(10) Pub. No.: US 2006/0133914 A1
(43) Pub. Date: Jun. 22, 2006

(54) Luggage carrier

(76) Inventor: John Derks, Barrie (CA)

Correspondence Address: BERESKIN AND PARR, 40 KING STREET WEST, BOX 401, TORONTO, ON, M5H 3Y2, CA

(21) Appl. No.: 11/016,834

(22) Filed: Dec. 21, 2004

(51) Int. Cl. B60P 9/00

(52) U.S. Cl. 414/462

(57) ABSTRACT

The rooftop carrier of the present invention includes a guide member mounted to the roof of a vehicle, wherein the guide member defines a substantially horizontal first path, and a carriage movably mounted to and configured to follow the guide member along the first path. The carriage comprises a moveable support member configured to receive an object to be carried by the carrier. The carriage also comprises an elevating system for elevating the support member along a second path between a raised height and a lowered height.

### FIELD OF THE INVENTION

This invention relates to the field of automobile rooftop luggage carriers.

### BACKGROUND OF THE INVENTION

Roof racks for transporting luggage and other objects are common on automobiles. For greater certainty, when used herein “luggage” is not intended to be limited to suitcases, travel chests or similar objects for transporting clothing, but rather is intended to encompass all types of objects which might be transported on an automobile roof rack, including canoes, camping equipment, ladders, lumber etc.

Loading luggage onto the roofracks of stationwagons or other “cars” with roofracks that are positioned approximately 4 feet off the ground can be difficult, particularly if the object is heavy. However, the difficulties of loading a roofrack are exacerbated on taller vehicles such as sport utility vehicles, minivans or regular vans, which may have a roof height of six feet or more off the ground.

Accordingly, the inventor has recognized the need for a luggage carrier to assist in loading luggage onto an automobile rooftop for transportation.

### SUMMARY OF THE INVENTION

The rooftop carrier of the present invention includes a guide member mounted to the roof of a vehicle, wherein the guide member defines a substantially horizontal first path, and a carriage movably mounted to and configured to follow the guide member along the first path. The carriage comprises a moveable support platform configured to receive an object to be carried by the carrier. The carriage also comprises an elevating system for elevating the support platform along a second path between a raised height and a lowered height.

### BRIEF DESCRIPTION OF THE DRAWINGS

The present invention will now be described, by way of example only, with reference to the following drawings, in which like reference numerals refer to like parts and in which:

FIG. 1A is a perspective view of a rooftop carrier made in accordance with the present invention;

FIG. 1B is a perspective view of a rooftop carrier of FIG. 1A, with a portion of the carrier cover removed;

FIG. 2 is an end view of the rooftop carrier of FIG. 1A, with the carriage in the secure position;

FIG. 3 is an end view of the rooftop carrier of FIG. 1A, with the carriage in the extended and raised position;

FIG. 4 is an end view of the rooftop carrier of FIG. 1A, with the carriage in the lowered position; and

FIG. 5 is a top perspective view of the rooftop carrier of FIG. 1A, with a portion of the cover removed.

### DETAILED DESCRIPTION OF THE INVENTION

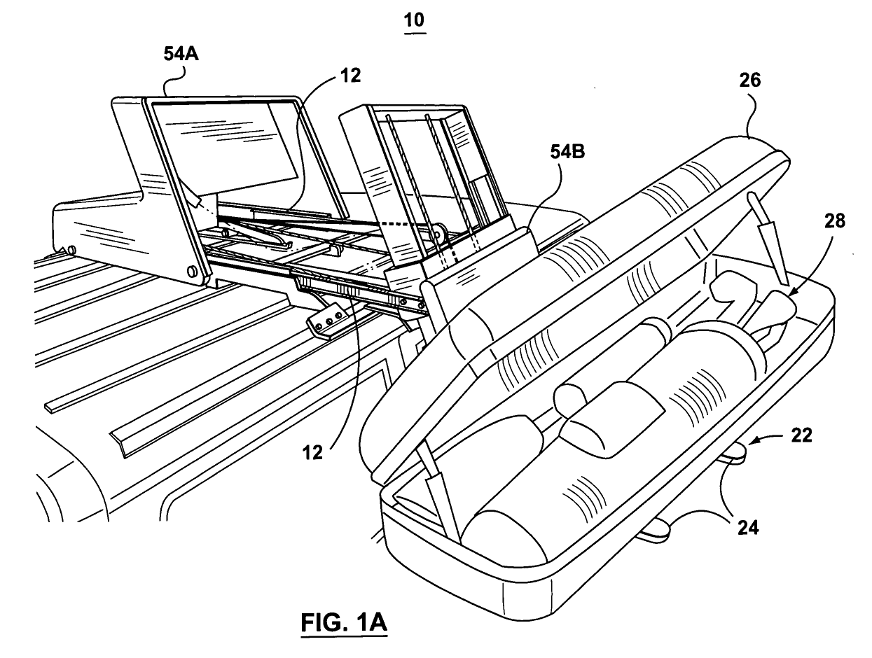

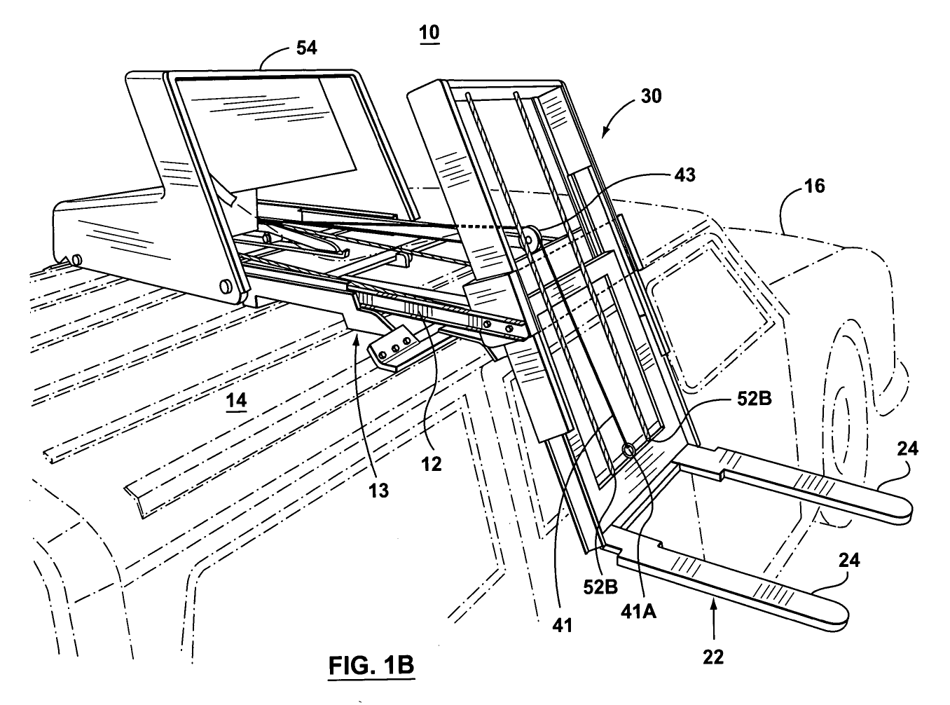

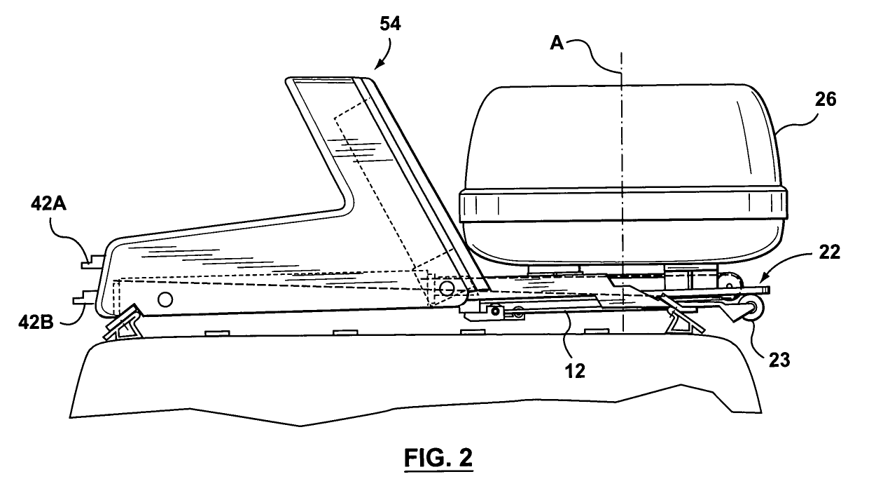

Referring to FIGS. 1A & 1B in combination with FIGS. 2 & 3, illustrated therein is a rooftop carrier, referred to generally as 10, made in accordance with the present invention. The carrier 10 includes a guide member in the form of first tracks 12 (preferably comprising telescoping track segments) mounted to a frame 13 which in turn is mounted to the rooftop 14 of a vehicle 16 and which define a first path substantially parallel to the line indicated generally as 20, proximate the tracks 12.

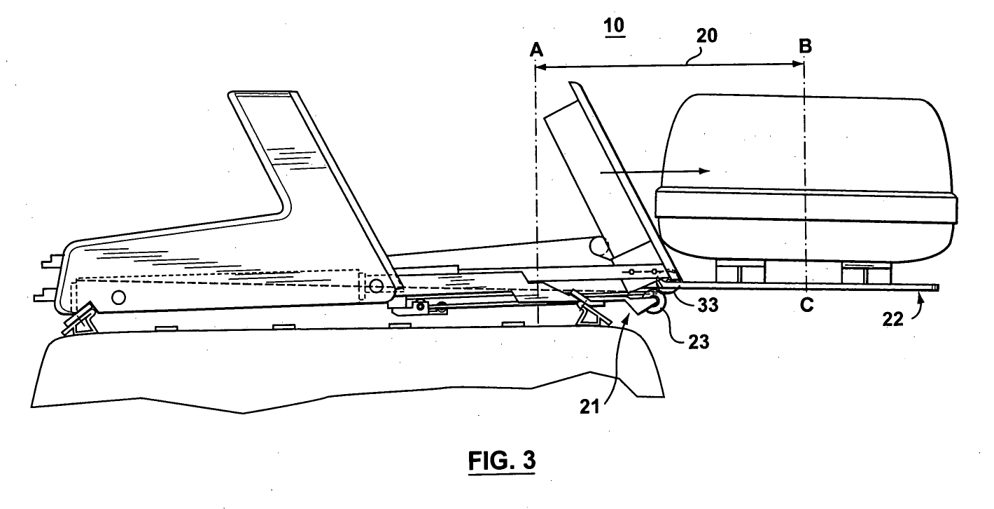

The path 20 is preferably substantially horizontal and extends from a secured position intersecting the line indicated generally as A (shown in FIG. 2) to an extended position beyond the edge of the rooftop 14 intersecting the line indicated generally as B (shown in FIG. 3). A movable carriage 21 is provided which may be mounted to the free/movable end of the telescoping track 12. One or more support rollers or wheels 23 may be mounted to the frame 13, for supporting the carriage 21 and facilitating horizontal movement of the carriage 21 along the path 20.

The carriage 21 is also provided with a carrying member or luggage platform 22, which is configured for receiving objects to be transported. The platform 22 may be provided with two support forks 24, although other suitable configurations are possible. For example, as illustrated in FIG. 1, a travel chest 26 capable of storing sports equipment and other luggage 28, may be removably mounted to the support member 22 (typically by straps or bungee cords, or by using nuts and bolts).

The carriage 21 is also provided with an elevating system 30 for elevating (ie. raising and lowering) the carrying member 22 along a second path 32. The path 32 includes a vertical component and is preferably substantially vertical, extending from a raised position or height indicated generally as C which is approximately level with the rooftop 14 to a lowered height or position indicated generally as D. The path 32 may be angled from the vertical to accommodate the angled profile of the side of the vehicle 16. As will be understood, when the platform is at raised position C, the carriage 21 is preferably coincident with extended position B.

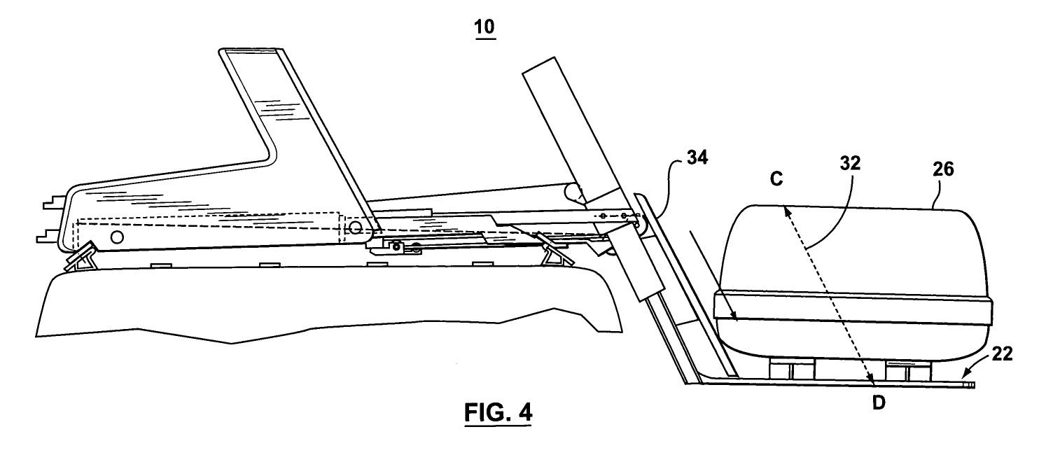

Preferably, the lowered height D is at an average person's waist height or other comfortable height for loading objects onto the carrier (eg. typically approximately 3-5 feet from the ground, although the lowered height may be higher or lower depending on the height of the vehicle 16). The elevating system 30 may be provided with second telescoping track 34 (which can be seen more easily in FIG. 4), and the platform 22 may be mounted to the free end of the telescoping track 34. The platform 22 may also be provided with one or more wheels 33 or other mechanism for facilitating movement along the tracks 34, and being guided along the path 32.

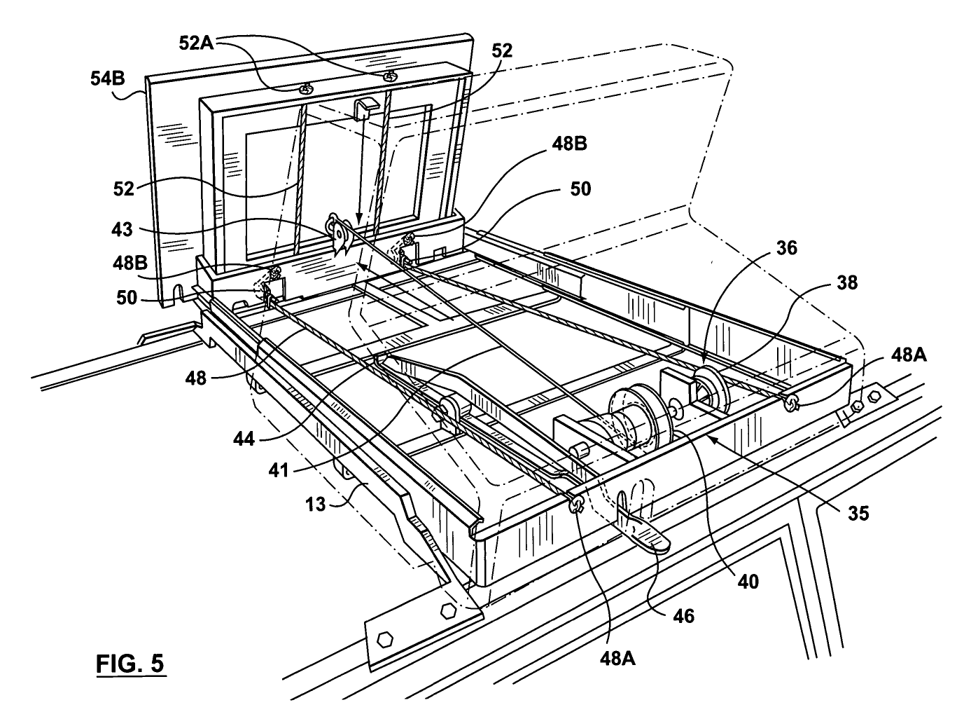

The carrier 10 is also preferably equipped with means for powering or assisting the movement of the carriage 21 and the platform 22 along the respective paths 20, 32. As can be seen more clearly in FIG. 5, this powering means 35 may include a winch 36 mounted to the frame 13 and having an electric motor 38 driving a wind-up reel 40 for winding up cabling 41 coupled to the carrying platform 22 (at its remote end 41A). Preferably, the motor 38 is operatively coupled to and receives electrical power from the vehicle's 16 electrical system, although the carrier may be provided with its own separate battery or other power source. As well, preferably an “up” switch 42A and a “down” switch 42B will be provided for establishing the appropriate electrical connections to the motor 38 to drive the winch in a forward (up) and a reverse (down) direction, respectively.

As will be understood, the winch 36 and cable 41 are able to provide an inward and substantially horizontal force on the carriage 21, sufficient to move the carriage 21 along from the extended position B towards the secured position A. A pulley 43 is preferably mounted to the carriage 21, for redirecting the cable's 41 force to include a substantially upward vertical component and enabling the winch 36 to raise the platform 22 from the lowered height D to the raised height C. The winch 36 and cable 41 form a powered lifting system for elevating the platform 22 from the lowered height D to the raised height C.

The carrier 10 may also be provided with a resilient catch 44 configured to releasably engage the carriage 21 and secure it in the secure position A. A corresponding release lever 46 is provided to release the carriage 21 from the catch 44 when it is desired to move the platform 22 down to the lowered position D.

It is also preferable for the powering means 35 to include a powered extension mechanism for moving or assisting the carriage 21 to be moved from the secured position A to the extended position B. In the carrier 10 as illustrated, extension bungee cords 48 may be provided which are coupled to the frame 13 at a first end 48A and which wrap around a bar or pulley 50 located proximate the remote edge of the rooftop 14 (ie proximate the loading side of the vehicle 16) before being coupled to the inward side of the carriage 21 at a second remote end 48B. The extension bungee cords 48 provide outward tension (ie. away from the secured position A and towards the extended position B), such that when the motor 38 is reversed (and the catch 44 released), the carriage 21 is drawn beyond the edge of the rooftop 14. Alternatively, springs or other tension devices may be used to appropriately push or pull the carriage 21 towards the extended position B.

Preferably, the platform 22 is of sufficient weight that gravity will provide enough downward force to lower the platform 22 from the raised height C to the lowered height D, when the motor 38 is reversed. However, as will be understood, if gravity is insufficient to move the platform 22 or to move the platform 22 downward at an acceptable pace, springs or other mechanical means may be provided to provide sufficient downward force on the platform 22.

Stabilizing bungee cords 52 may also be provided which are coupled to the carriage 21 at a first end 54 and which are coupled to the platform 22 at a second end 56. The stabilizing cords 52 are placed under tension as the platform 22 descends from the raised position C to the lowered height D. The cords 52 provide stability to the platform 22 as it is raised and lowered, helping to prevent the telescoping track 34 from binding.

A cover 48 for protecting the motor 38 and corresponding electrical connections from the outside environment, is preferably provided. Preferably, the cover 48 is streamlined to provide improved airflow over the carrier 10 and correspondingly reduced wind-resistance when the vehicle 16 is in motion.

In use, the carriage 21 may first be secured in the secured position A (illustrated in FIG. 2). The release lever 46 may be depressed, causing the catch 44 to disengage from the underside of the carriage 21. As the catch 44 is disengaged, the down switch 42B is activated by the user, completing the electrical circuit and causing the motor 38 to turn the wind-up reel 40 in reverse and unwind the cable 41.

As the cable 41 is unwound, the extension bungee cords 48 draw the carriage 21 towards the extended position B. As the carriage 21 travels toward the extended position, the telescoping track 34 is also drawn to its extended position. Additionally, as the platform 22 rolls horizontally it is supported by support wheels 23. The carriage 21 reaches the extended position B once the platform 22 has been extended beyond the support of the wheels 23 (as illustrated in FIG. 3).

As the carriage 21 reaches the extended position B and platform 22 is no longer supported by the support wheels 23, gravity draws the platform 22 downward from the raised height C. As the platform 22 lowers to the lowered height D, the telescoping track 34 extends, and the stabilizing cords 52 are stretched, providing stabilizing tension to the platform 22. Once the platform 22 reaches the lowered height D (illustrated in FIG. 4), the down switch 42B may be released, breaking the electrical circuit and causing the winch 36 to stop unwinding the cable 41. Alternatively, the powering means 35 may be provided with a timing circuit or trip switch for discontinuing the power supply to the motor 38 once the platform 22 has been completely lowered.

In the lowered position D, the travel trunk 24 may be loaded or unloaded, as necessary (as illustrated in FIG. 1A). Once the loading or unloading is complete, the user activates the up switch 42A, completing the electrical circuit and causing the motor 38 to turn the wind-up reel 40 in forward direction and wind up the cable 41. As the cable 41 is wound up by the winch 36, the cabling 41 provides vertical force to the platform 22, raising it from the lowered position D to the raised position C, and correspondingly causing the telescoping track 34 to retract.

Once the platform 22 has been raised to the raised height C (illustrated in FIG. 3), the cabling 41 provides inward horizontal force to the carriage 21, drawing it in towards the secured position A. At the same time, the telescoping track 12 is retracted. As the carriage 21 reaches the secured position, the catch 44 resiliently engages the carriage's 21 underside, and is secured in place. Once the carriage 21 is secured in the secured position A (illustrated in FIG. 2), the up switch 42A may be released, breaking the electrical circuit and causing the winch 36 to stop winding up the cable 41. Alternatively, the powering means 35 may be provided with a timing circuit or trip switch for discontinuing the power supply to the motor 38 once the carriage 21 reaches the secured position.

As will be understood, as an alternative to (or in part in addition to) the winch 36 and cable 41 and extension bungee cords 48, the powering means 35 may include pneumatic or hydraulic pistons for moving the carriage 21 horizontally between the secured and extended positions A, B and the platform 22 vertically between the upper and lower heights C, D.

Thus, while what is shown and described herein constitutes preferred embodiments of the subject invention, it should be understood that various changes can be made without departing from the subject invention, the scope of which is defined in the appended claims.

1. A rooftop carrier comprising:
a) a guide member mounted to the roof of a vehicle, wherein the guide member defines a substantially horizontal first path;
b) a carriage movably mounted to and configured to follow the guide member along the first path;
c) wherein the carriage comprises a moveable support platform configured to receive an object to be carried by the carrier; and
d) wherein the carriage also comprises an elevating system for elevating the support platform along a second path between a raised height and a lowered height.

2. The rooftop carrier as claimed in claim 1, wherein the elevating system comprises a powered lifting mechanism configured to lift the carrying member from the lowered height to the raised height.

3. The rooftop carrier as claimed in claim 2, wherein the lifting mechanism comprises a winch.

4. The rooftop carrier as claimed in claim 3, wherein the winch is operatively coupled to the roof of the vehicle and comprises a cable operatively coupled to the support platform.

5. The rooftop carrier as claimed in claim 1, wherein the guide member comprises a first track.

6. The rooftop carrier as claimed in claim 5, wherein the first track comprises at least one telescoping segment.

7. The rooftop carrier as claimed in claim 1, wherein the guide member extends between an extended position proximate an edge of the roof and a secured position remote from the edge.

8. The rooftop carrier as claimed in claim 7, wherein the elevating system comprises a second track.

9. The rooftop carrier as claimed in claim 8, wherein the second track comprises at least one telescoping segment.

10. The rooftop carrier as claimed in claim 1, further comprising power means for moving the carriage between an extended position and a secured position.

11. The rooftop carrier as claimed in claim 10, wherein the power means comprises a winch and a cable operatively coupled to the carriage.
